(19) United States
(12) Patent Application Publication
(10) Pub. No.: US 2018/0020216 A1
(43) Pub. Date: Jan. 18, 2018

(54) METHOD FOR ENCODING A DIGITAL IMAGE, DECODING METHOD, DEVICES, AND ASSOCIATED COMPUTER PROGRAMMES

(71) Applicants: B<>COM, Cesson Sevigne (FR); Orange, Paris (FR)

(72) Inventor: Pierrick Philippe, Melesse (FR)

(21) Appl. No.: 15/549,298

(22) PCT Filed: Feb. 5, 2016
(86) PCT No.: PCT/FR2016/050246

§ 371 Date: Aug. 7, 2017

(30) Foreign Application Priority Data
Feb. 6, 2015 (FR) 1550984

(51) Int. Cl. H04N 19/122; H04N 19/157; H04N 19/124; H04N 19/18; H04N 19/61; H04N 19/96; H04N 19/176

(52) U.S. Cl. CPC H04N 19/122; H04N 19/18; H04N 19/157; H04N 19/61; H04N 19/124; H04N 19/176; H04N 19/96

(57) ABSTRACT

An encoding method encodes a digital image that is divided into a plurality of blocks of pixels processed in a defined order. The method includes: transforming the current block into a transformed block with coefficients, by implementing two successive transformation sub-steps, one to the current block and the other to an intermediate block, resulting from the first sub-step; and quantizing and encoding the coefficients of the transformed block. The transforming step further comprises, a preliminary sub-step of forming at least one first and one second distinct vector, in the block to be transformed, each vector comprising the pixels, respectively the coefficients of a sequence of pixels, respectively adjacent coefficients of the block to be transformed, of length equal to one of the sizes of the block to be transformed. The transformation sub-step also includes applying a first transform to the first vector and a second transform to the second vector.

### 1. CROSS-REFERENCE TO RELATED APPLICATIONS

This application is a Section 371 National Stage application of International Application No. PCT/FR2016/050246, filed Feb. 5, 2016, the content of which is incorporated herein by reference in its entirety, and published as WO 2016/124867 on Aug. 11, 2016, not in English.

### 2. FIELD OF THE INVENTION

The field of the invention is that of signal compression, in particular of a digital image or of a sequence of digital images, divided into blocks of pixels.

The encoding/decoding of digital images applies in particular to images from at least one video sequence comprising:
Images from the same camera and succeeding each other temporally (type-2D encoding/decoding),
Images from different cameras oriented according to different views (3D-type encoding/decoding),
Components of corresponding texture and depth (3D-type encoding/decoding),
etc.

The present invention applies in a similar manner to the 2D- or 3D-type encoding/decoding of images.

The invention may especially, but not exclusively, apply to the video encoding implemented in the current AVC (Advanced Video Coding) and HEVC (High Efficiency Video Coding) video encoders and their extensions (MVC, 3D-AVC, MV-HEVC, 3D-HEVC, etc.) and to corresponding decoding.

### 3. DESCRIPTION OF PRIOR ART

A conventional compression scheme of a digital image is considered, in which the image is divided into blocks of pixels. A current block to be coded, which constitutes an initial coding unit, is generally cut into a variable number of sub-blocks according to a predetermined cutting mode. In connection with FIG. 1, we consider a sequence of digital images I1, I1, Ik, IK, with non-zero integer K. An image Ik is cut into Coding Tree Units (CTUs) according to the HEVC terminology as specified in the document “ISO/IEC 23008-2:2013—High efficiency coding and media delivery in heterogeneous environments—Part 2: High efficiency video coding>>, International Organization for Standardization, published in November 2013. The standard encoders typically provide a regular partitioning which is based on square or rectangular blocks, known as CUs (for “Coding Units”) of a fixed size. Partitioning is always done from the initial non-partitioned encoding unit, and the final partitioning is calculated and then signalled from this neutral basis. Examples of partitioning authorised by the HEVC standard are presented in relation to FIG. 2.

Each CU will undergo an encoding or decoding operation consisting of a sequence of operations, including in a non-exhaustive manner a prediction, a residue calculation, a transformation, a quantization and an entropic coding. This sequence of operations is known from the prior art and presented in relation to FIG. 3.

The first block CTU to be processed is selected as current block b. For example, this is the first block (in lexicographic order). This block comprises N×N pixels, with N non-zero integer, for example equal to 64 according to the HEVC standard.

It is assumed that there are L partitionings into possible PU blocks numbered from 1 to L, and that the partitioning used on the block b corresponds to the partitioning number I. For example, there can be 4 possible partitionings, in sub-blocks of size 4×4, 8×8, 16×16, and 32×32 according to a regular mode of “quad tree”-type cutting. As previously mentioned, some PU blocks may be rectangular.

During a step E1, a prediction Pr of the original block b is determined. It is a prediction block constructed by known means, typically by motion compensation (a block originating from a previously decoded reference image) or by intra prediction (a block constructed from the decoded pixels immediately adjacent to the current block in the ID image). The prediction information related to P is encoded in the bit stream TB or compressed file FC. It is assumed here that there are K possible prediction modes m1, m2, . . . , mK, with K a non-zero integer. For example, the prediction mode chosen for the current block b is the mode mk. Some prediction modes are associated with an Intra-type prediction, others with an INTER-type prediction, and others with a MERGE-type prediction.

During a step E2, an original residue R is formed by subtraction of R=b-Pr from the prediction Pr of the current block b in the current block b.

During a step E3, the residue R is transformed into a transformed residue block, called RT, by a DCT-type transform or transformed into wavelets, both known to those skilled in the art and in particular implemented in the JPEG/MPEG standards for the DCT and JPEG2000 for the wavelet transform.

At E4, the transformed residue RT is quantized by conventional quantization means, for example scalar or vector, into a quantified residue block RQ, comprising as many coefficients as the residual block RQ contains pixels, for example Nb, with Nb a non-zero integer. In a manner known in the state of the art, these coefficients are scanned in a predetermined order so as to constitute a monodimensional vector RQ [i], where the index i varies from 0 to Nb−1. The index i is called the frequency of the coefficient RQ [i]. Conventionally, these coefficients are scanned in ascending order of frequency, for example according to a zigzag path, which is known from the JPEG fixed image encoding standard.

During a step E5, the amplitude information of the coefficients of the residual block RQ is encoded by entropic coding, for example according to a Huffman encoding technique or an arithmetic encoding technique. By amplitude herein is meant the absolute value of the coefficient. Conventionally, it is possible to encode for each coefficient information representative of the fact that the coefficient is non-zero. Then, for each non-zero coefficient, one or more pieces of information relating to the amplitude are encoded. The encoded amplitudes CA are obtained. In general, the signs of the non-zero coefficients are simply coded by a bit 0 or 1, each value corresponding to a given polarity. Such encoding provides efficient performances because, due to the transformation, the values of the amplitudes to be encoded are largely equal to zero.

The preceding steps E1 to E5 are repeated for the possible I partitionings of the current block b. For partitioning I, each of the sub-blocks CU of the current block b are processed as described above, a type of prediction (Inter or Intra) being authorised for each CU. In other words, the sub-blocks PU of a sub-block CU are all subjected to the same type of prediction.

For example, the coded data for each of the possible partitioning I are competed according to a rate-distortion criterion and the partitioning which obtains the best result according to this criterion is finally adopted.

The other blocks of the image I1 are processed in the same way, as for the following images in the sequence.

The transformation step plays a crucial role in such a video coding scheme: indeed, it concentrates the information before the quantization operation. Thus, a set of residual pixels before encoding is represented on a small number of transformed coefficients, also called non-zero frequency frequencies representing the same information.

Thus, instead of transmitting a large number of coefficients, only a small number will be necessary to reliably rebuild a block of pixels.

The efficiency of a transformation is commonly measured according to an energy concentration criterion, also given in the form of a coding gain: it represents, for a given bit rate, the reduction in distortion (expressed by the mean squared error) when coding takes place in the transformed domain rather than in the spatial domain.

σ_{transform}² denotes the mean squared error after quantisation carried out in the transformed domain and σₛₚₐₜᵢₐₗ² denotes the squared error for a quantization with the same precision in the spatial domain, i.e. the residual before processed.

According to these notations, the coding gain is then expressed:

$${G}_{TC} = \frac{{σ}_{spatial}^{2}}{{σ}_{transform}^{2}}$$

Usually this gain is expressed in dB

Gtc_db=10*log 10(Gtc)

The gain realised in distortion by the use of transforms can also be transcribed as a gain in bit rate: at high bit rate, the gain in dB divided by a value of 6.02 makes it possible to approximate the actual bit rate economy, expressed in bit per pixel.

In image and video encoding, the most used transforms are linear, orthogonal or quasi-orthogonal transforms (4×4, 8×8 etc). A linear transform can be expressed as a matrix as follows. An orthogonal transform has as characteristic property the fact that the inverse transformation matrix is the transposition of the direct transformation matrix. Thus, such a transformation has the property:

A^{t}A=AA^{t}=cI

Where A is the matrix with the direct transformation and I the identity matrix and c is a numerical value. When c is 1, matrix A is orthonormal. A quasi-orthogonal matrix, multiplied by its inverse, has an approximate quantity close to the identity matrix within one factor.

The most used transforms are based on cosine bases. The DCT is thus present in most image and video compression standards. Recently, the HEVC standard also introduced DST (Discrete Sine Transform) for the coding of specific residues in the case of 4×4 size blocks.

In fact, approximations of these transforms are used, the calculations being carried out on integers. In general, the transform bases are approximated to the nearest integer with a given precision (usually 8 bits).

As an example we present in connection with FIGS. 4A and 4B, the transforms used by the HEVC standard blocks of 4×4 size.

These are the DCT and DST transforms. The values presented in this table are to be divided by 128 to recover quasi-orthonormal transformations.

In practice, a block of pixels is transformed by the following operations:

X=A·(A·x^{t})^{t} (1)

A denotes the transformation matrix of size N×N, x represents the residual pixels or pixels to be transformed (spatial domain), X the block in the transformed domain (called frequency domain) and t the transposition operator.

The block in the spatial domain is written (here in 4×4):

$$x = [ \begin{matrix}{x}_{0} & {x}_{1} & {x}_{2} & {x}_{3} \\ {x}_{4} & {x}_{5} & {x}_{6} & {x}_{7} \\ {x}_{8} & {x}_{9} & {x}_{10} & {x}_{11} \\ {x}_{12} & {x}_{13} & {x}_{14} & {x}_{15}\end{matrix} ]$$

The block of pixels in the transformed domain takes the form:

$$X = [ \begin{matrix}{X}_{0} & {X}_{1} & {X}_{2} & {X}_{3} \\ {X}_{4} & {X}_{5} & {X}_{6} & {X}_{7} \\ {X}_{8} & {X}_{9} & {X}_{10} & {X}_{11} \\ {X}_{12} & {X}_{13} & {X}_{14} & {X}_{15}\end{matrix} ]$$

The matrix A takes the form of a 4×4 matrix in our case, with coefficients equal to those presented in the tables of FIGS. 4A and 4B.

The equation presented above thus proceeds as follows:
The block x is transposed.
Thus, the matrix A applies to the lines of pixels
The result (A·x^{t}) is then transposed
Then, the application of the matrix A is based on this result.

The combination of these operations is then to transform the lines and then the columns.

A writing equivalent from a coding point of view but different from a mathematical point of view consists in performing:

X=A·(A·x)^{t} (2)

In this case, the columns are transformed first.

The lines and lines transforms may be different, as described in the prior art cited. The preceding formulas can be extended to this case, for example if one wishes to operate on the columns first and then on the lines:

X=L·(C·x)^{t} (3)

L is the line-specific transform and C is the column-specific transformation.

To operate on the lines beforehand, the following equation can be written:

X=C·(L·x^{t})^{t} (4)

These last two formulas also make it possible to process rectangular blocks of pixels, thus an 8×8 column transform can operate on a 4×8 block in a first step, in a second step a 4×4 line transform will operate on the resulting block to finally obtain the transformed coefficients.

Thus we write in the same way as before:

X=L·(C·x)^{t} (5)

It can be seen that two separate transformations are made in the line-column or line-column direction. Thus the spatial signal is decorrelated by lines vectors then columns or columns and then lines.

Decorrelation is indeed an important aspect in transformation. Ensuring a good decorrelation allows to obtain a good coding gain.

The transformation operations presented above act separately by line then column decorrelation or column and then line decorrelation. These are so-called separable transforms.

Consequently, they do not allow complete decorrelating of the pixels in the spatial domain, in particular the decorrelation of diagonal elements, such as x0 and x5.

To enable a complete decorrelation, it is possible to carry out a non-separable transformation. To do this, we apply the following operator:

\vec{X}=Aₙₛ·\vec{x} (6)

Aₙₛ represents the non-separable processing to be performed, advantageously chosen as orthonormal or quasi-orthonormal, \vec{X} et \vec{x} and are then respectively processed pixels in the spatial domain, formed into vectors. Thus for a 4×4 block they take the following form:

$${X}^{->} = [ \begin{matrix}{X}_{0} \\ {X}_{1} \\ ⋮ \\ {X}_{14} \\ {X}_{15}\end{matrix} ] and {x}^{->} = [ \begin{matrix}{x}_{0} \\ {x}_{1} \\ ⋮ \\ {x}_{14} \\ {x}_{15}\end{matrix} ]$$

Aₙₛ is thus of size 16×16 in this example, and more generally of size N²×N² for an N×N size block composed of N² pixels.

In this way a non-separable transformation Aₙₛ is capable of processing frontally all correlations between pixels of the spatial domain, including diagonal correlations. For example, in the case of a 4×4 block, the direct correlation between the pixel x0 and x5 is reduced.

As a result, the non-separable transforms are more efficient in compression, nevertheless they have a certain number of disadvantages:
These are transforms of size N²×N², so N⁴ values must be stored, compared to the 2×N² values required for the two matrices performing the separable transform. This has an impact on the cost of implementing an image/video encoder/decoder for which the fast memories are expensive.
The transformation algorithm requires a significantly higher number of operations to handle the increased size of the vector.

Compared with separable transformations, the non-separable transformations therefore require a much higher complexity, as shown in the table of FIG. 5. In this table, the quantities of memory and operations related to implementations of transforms that are not separable (Nsep) and separable (Sep) are listed for the processing of 4×4 and 8×8 blocks respectively.

As can be seen, the non-separable transformations have a significant impact in ROM and many operations compared to separable transforms. In particular, in terms of operations, the complexity ratio is greater than M/2, for a block of size M×M.

In addition, the patent application published under number US2013/0003828 discloses an image encoding method which selects types of transforms to be applied successively to the lines and to the columns of the block based on the prediction mode chosen for this block, for example an intra-directional prediction mode of particular direction. More precisely, this method associates a first linear transform to the lines of the current block, for example a DCT, and a second, linear transform, distinct from the first, to the columns of the block transformed by the first transform.

An advantage is to adapt to the fact that the set of columns and the set of lines of the block do not necessarily have the same statistical properties.

### 4. SHORTCOMINGS OF THE PRIOR ART

The disadvantages of the prior art are the following:
For a non-separable transform, the algorithmic complexity is quite significant. It therefore requires a very high, or even prohibitive, implementation cost.
In the case of separable transforms, they act identically for lines or columns, in particular it is implicitly assumed that respectively the set of lines or columns respectively shares the same statistics. These are the most used transforms in current encoders because they provide a compromise between compression efficiency and encoding cost. However, they do not reach the compression performances of the non-separable transforms.

### 5. SUMMARY OF THE INVENTION

These objects, as well as others which will appear hereinafter, are achieved by means of a method for encoding a digital image, said image being divided into a plurality of blocks of pixels processed in a defined order, said method comprising the following steps, implemented for a current block, with predetermined sizes:
Transforming the current block into a transformed block, said block comprising coefficients, said step implementing two successive transformation sub-steps, the first sub-step being applied to the current block and the second sub-step to the intermediate block, resulting from the first sub-step, said intermediate block comprising coefficients, and
Quantizating and encoding the coefficients of the transformed block.

According to the invention, prior to at least one of said transforming sub-steps, said sub-step being applied to a block, to be transformed, among the current block and the intermediate block, the method comprises a preliminary step of forming at least a first and a second distinct vectors in the block to be transformed, such a vector comprising the pixels, respectively the adjacent coefficients of a sequence of length equal to one of the sizes of the block to be transformed and said at least sub-step comprises applying a first transform to said at least one first vector and at least one second transform, distinct from said first one, to said at least one second vector of said block.

According to the invention, at least one of the two successive steps of the separable transformation applied to the current block implements at least two distinct transforms, which are applied to distinct vectors, with a size equal to that of a line, respectively, of a column of the current block and formed from a sequence of neighbouring elements of the current block.

Thus, the invention relies on an entirely novel and inventive approach of image coding by transforming the pixels of the current block in the spatial domain into coefficients in the frequency domain, which provides for a different processing for two vectors in the current block.

Contrary to the prior art which is based on the reducing hypothesis of common statistics shared by the set of lines or columns of the same block of the image to be coded, the invention takes into consideration the fact that two vectors distinct from a block and of the same size may have different statistical properties, which require a suitable linear transformation.

The invention presents the same algorithmic complexity as the prior art, but makes it possible either to improve the coding performance, that is to say to improve the quality of the coded image sequence for a given bit rate, or to lower the encoding bit rate for a given quality.

According to an advantageous characteristic of the invention, the method further comprises a prior step for determining said at least two distinct transforms to be applied to said vectors, at least based on of at least one coding parameter of the current block.

An advantage of associating the choice of the transforms with a coding parameter is to adapt to the statistical variations of the block induced by the parameter in question. For example, the encoding parameter considered is the block size or the prediction mode applied to it.

For example, preliminary experiments are used to associate the coding parameter under consideration with at least two linear transforms. An advantage is that the encoder is not made more complex:

According to another aspect of the invention, the determining step comprises reading information stored in memory, said information comprising at least the coding parameter, an identifier of the first transform, at least one identifier of the first vector of the block or of the intermediate block, an identifier of at least one second transform, distinct from the first and at least one second vector identifier of said block.

An advantage is that no additional information is signalled in the bit stream, the data stored in memory being duplicated on the decoder side.

For example, the memory is organised according to a database. An entry in the database associates, with a coding parameter transformation, identifiers to be applied to vector identifiers.

According to one aspect of the invention, said transformation step comprises a sub-step of rearranging the coefficients of the transformed vectors in the intermediate, respectively transformed block.

Following the application of the linear transforms to the vectors formed in the block to be transformed, the coefficients obtained are rearranged so as to form a block of coefficients. For example, the coefficients of the first transformed vector are placed on the first line, respectively the first column of the block. This particular embodiment has the advantage of being simple and of having little impact on the encoder.

According to yet another aspect of the invention, the encoding method further comprises the following steps of:
Predicting values of the current block from at least one block previously processed according to a mode of prediction selected among a plurality of predetermined modes,
Calculating a residual block by subtracting the predicted values from the original values of the current block.

According to the invention, the transforming step is applied to the residual current block and said at least one coding parameter is the prediction mode of the current block.

It has been found that the mode of prediction is representative in itself of the statistical properties of a residual block and that it is pertinent to associate a particular choice of linear transforms with a particular value of this coding parameter.

According to another aspect of the invention, the method comprises a step of identification information coding of said at least one first transform and of said at least one second transform.

The information relating to the linear transforms used is transmitted in the bit stream. An advantage of this embodiment is that it is suitable for dynamic determination of the transforms by the encoder for each processed block.

According to yet another aspect, the first transform is applied to a first sub-set of the vectors having sizes equal to that of a line respectively to those of a column of the block and said at least one second transform is applied to a second sub-set of vectors of sizes equal to that of a line of the block, respectively to those of a column of said block.

For example, two transforms are implemented, which are respectively transforms of lines or columns, per transformation sub-step. The two transforms are for example associated with a prediction mode of the current block. This embodiment achieves a compromise between the cost of storing the associations between vector identifiers and transform identifiers and compression performance.

According to yet another aspect of the invention, said at least one transformation sub-step implements a distinct transform per vector of size equal to that of a line of the block, or that of a column, formed in the block.

An advantage of this embodiment is that it makes it possible to adapt finely to the statistics of each vector of the block to be processed and to improve the performances of the encoder in terms of quality and/or compression.

According to another aspect of the invention, the vectors formed belong to a group comprising:
“lines” vectors of formed pixels respectively coefficients of a line of the current block;
“columns” vectors of formed pixels respectively coefficients of a column of the current block;
vectors of a length equal to that of a line of the block, formed by adjacent pixels or coefficients, adjacent to the current block from at least two lines of the block
vectors of a length equal to that of a column of the block, formed by adjacent pixels or coefficients, adjacent to the current block from at least two columns of the block

The formed vectors are of the same size as the lines or columns of the current block in order not to increase the complexity of the encoder.

A vector according to the invention is not necessarily formed exclusively from elements of the same line. Non-linear vectors may advantageously be formed from neighbouring elements of the block originating from neighbouring lines, which makes it possible to take advantage of particular correlations between adjacent elements of the considered block, off-line and columns. This case is particularly present for the diagonal angular prediction modes, for which the blocks to be encoded have diagonal patterns.

The method which has just been described in its various embodiments is advantageously implemented by a device for encoding a digital image according to the invention comprising the following units, capable of being implemented for a current block, of predetermined size:
Transforming the current block into a transformed block, said block comprising coefficients, said step implementing two successive transforming sub-steps, the first sub-step being applied to the current block and the second sub-step to the intermediate block, resulting from the first sub-step, said intermediate block comprising coefficients, and
Quantization and encoding the coefficients of the transformed block.

Such a device is particular in that it comprises a unit of forming at least one first and one second distinct vectors in a block, a so-called block to be transformed, among the current block and the intermediate block, such a vector comprising the pixels, respectively the adjacent coefficients of a sequence of length equal to one of the sizes of the block to be transformed and said at least one sub-step comprises applying a first transform to said at least one first vector and at least one second transform, distinct from said first one, to said at least one second vector of said block.

Correlatively, the invention also relates to a method for decoding a digital image from a bit stream comprising encoded data representative of said image, said image being divided into a plurality of blocks of pixels processed in a defined order, said method comprising the following steps, implemented for a block, so-called current block:
Decoding the coefficients of the transformed current block from data read in the bit stream;
Dequantizatng the decoded coefficients;
Inverse transforming of the current transformed block, said step implementing two successive inverse transforming sub-steps, the first sub-step being applied to the current block and the second sub-step to the intermediate block, resulting from the first sub-step.

The decoding method according to the invention is particular in that:
said at least one inverse transforming sub-step being applied to a block, so-called block to be processed, from the current transformed block and the intermediate block, it comprises applying a first inverse transform to at least a first vector of a length equal to that of one line or one column of the block to be processed and at least one second inverse transform distinct from the first to at least one second vector of said block of length equal to that of one line or one column, respectively; and
it further comprises a sub-step of forming the processed block, by positioning sequences of adjacent coefficients, respectively adjacent pixels of lengths equal to that of a column respectively a line, from the processed vectors.

According to an aspect of the invention, the method further comprises a prior step for determining said at least two distinct transforms to be applied to said first and second vectors, of the block to be processed, at least based on of at least one coding parameter of the current block.

According to another aspect, the determining step comprises a reading in the bit stream of coded data representative of identification information of the at least one first transform and of said at least one second transform.

According to yet another aspect of the invention, the determining step further comprises a prior sub step of forming the first and second vectors in the block to be processed.

According to yet another aspect of the invention, the determining step comprises reading information stored in memory, said information comprising at least the coding parameter, an identifier of the first inverse transform, at least one identifier of the first vector, an identifier of at least one second transform, distinct from the first and at least one second vector identifier of the block to be processed.

According to another aspect of the invention, the inverse transforming step further comprises a sub-step, prior to said at least one sub step of transformation, of rearranging sequences of adjacent coefficients of the block to be processed in said first and second vectors, such a sequence having a length equal to one of the size of the block to be processed.

The decoding method according to the invention thus implements the inverse operations to that of the coding method which has just been described.

In particular:
the sub-steps of inverse transformation correspond to the operations inverse to those of transformation implemented by the coding method. They follow one another in the reverse order of coding.
the sub-step for forming the block processed from sequences of adjacent coefficients, respectively adjacent pixels, derived from the processed vectors, corresponds to the inverse operation of that of forming the vectors to be transformed, implemented by the coding method;
the sub-step of rearranging sequences of adjacent coefficients of the block to be processed in said first and second vectors corresponds to the inverse operation of that of rearranging the coefficients of the transformed vectors in the transformed block, implemented by the coding method.

The method which has just been described in its different embodiments is advantageously implemented by a device for decoding a digital image from a bit stream comprising encoded data representative of said image, said image being divided into a plurality of blocks of pixels processed in a defined order, said device comprising the following units, which can be implemented for a block of predetermined sizes, so-called current block:
Decoding the coefficients of the transformed current block from data read in the bit stream;
Dequantizating the decoded coefficients;
Inverse transforming of the current transformed block, said unit implementing two successive inverse transforming sub-units, the first sub-unit being applied to the current block and the second sub-unit to the intermediate block, resulting from the first sub-unit;

According to the invention, the device is particular in that it comprises:
at least one inverse transforming sub-unit of a block, so-called block to be processed, from the current transformed block and the intermediate block, comprises applying a first inverse transform to at least a first vector of a length equal to that of one line or one column of the block to be processed and at least one second inverse transform distinct from the first to at least one second vector of said block of length equal to that of one line or one column, of said block to be treated;
and in that the inverse transforming unit further comprises an inverse formation sub-unit of a processed block, by positioning sequences of adjacent coefficients, respectively adjacent pixels of lengths equal to that of a column respectively a line, from the processed vectors.

The invention further relates to a signal carrying a bit stream including encoded data of a digital image, said image being divided into blocks of pixels. Such a signal is particular in that it comprises, for a current block:
coded data representative of an identification information of at least a first and a second transform, distinct from each other, implemented during the coding of the current block during a transformation step of the current block into a transformed block, comprising two successive sub-steps of transformation of the current block into a transformed block, at least one transformation sub-step comprising applying a first transform to at least one first vector and at least one second transform, distinct from the first, to at least a second vector of a block, so-called a block to be transformed, among the current block and the intermediate block, and
coded data representative of at least the first and second vectors formed in the block to be transformed, from a sequence of adjacent pixels or adjacent coefficients, said sequence having a length equal to one of the sizes of the block to be transformed.

The invention also relates to a computer terminal comprising a device for coding a digital image according to the invention and a device for decoding a digital image according to the invention.

The invention also relates to a computer programme comprising instructions for implementing the steps of a method for encoding a digital image as described above, when this program is executed by a processor.

The invention also relates to a computer programme comprising instructions for implementing the steps of a method for decoding a digital image as described above, when this programme is executed by a processor.

These programmes can use any programming language. They can be downloaded from a communication network and/or recorded on a computer-readable medium.

Finally, the invention relates to recording media, readable by a processor, integrated or not integrated with the encoding device of a digital image and with the device for decoding a digital image according to the invention, optionally removable, storing respectively a computer programme implementing an encoding method and a computer programme implementing a decoding method, as described above.

### 6. LIST OF FIGURES

Other features and advantages of the invention will become evident on reading the following description of one particular embodiment of the invention, given by way of illustrative and non-limiting example only, and with the appended drawings among which:

FIG. 1 (already described) schematically illustrates a sequence of digital images to be encoded and the division into blocks of these images according to the prior art;

FIG. 2 (already described) shows various possibilities of partitioning a block into sub-block according to the prior art;

FIG. 3 (already described) shows schematically the steps of a method of encoding a digital image according to the prior art;

FIGS. 4A and 4B (already described) show two examples of frequency transforms approximated according to the prior art;

FIG. 5 (already described) shows a comparative table of separable transforms complexity measures and non-separable transforms;

FIG. 6 shows schematically the steps of an encoding method of a digital image according to an embodiment of the invention;

FIG. 7A illustrates the elements of a current block;

FIGS. 7B, 7C and 7D illustrate examples of forming “rows” and “columns” vectors from elements of the current block of FIG. 7A, according to the invention;

FIG. 8A shows a first example of estimation of energy values at the pixels of a current block and FIG. 8B shows homogeneous regions determined in the block from the estimated energy levels;

FIG. 9A shows a second example of estimation of energy values at the pixels of a current block and FIG. 9B shows homogeneous regions determined in the block from the estimated energy levels;

FIG. 10 explains the steps of forming vectors and transforming vectors formed according to a second embodiment of the invention;

FIG. 11 shows the compression gains obtained by the encoding method according to this second embodiment compared to the prior art;

FIG. 12 explains the steps of forming vectors and transforming vectors formed according to a third embodiment of the invention;

FIG. 13 shows the compression gains obtained by the encoding method according to this third embodiment compared to the prior art;

FIG. 14 shows schematically the steps of a method for decoding a digital image according to an embodiment of the invention; and

FIG. 15 shows an example of simplified structure of a coding device of a digital image and a device for decoding a digital image according to one embodiment of the invention.

### 7. DESCRIPTION OF A PARTICULAR EMBODIMENT OF THE INVENTION

The general principle of the invention relies on the application of distinct transforms to different vectors of a size equal to that of a line, respectively a column, of a block to be coded.

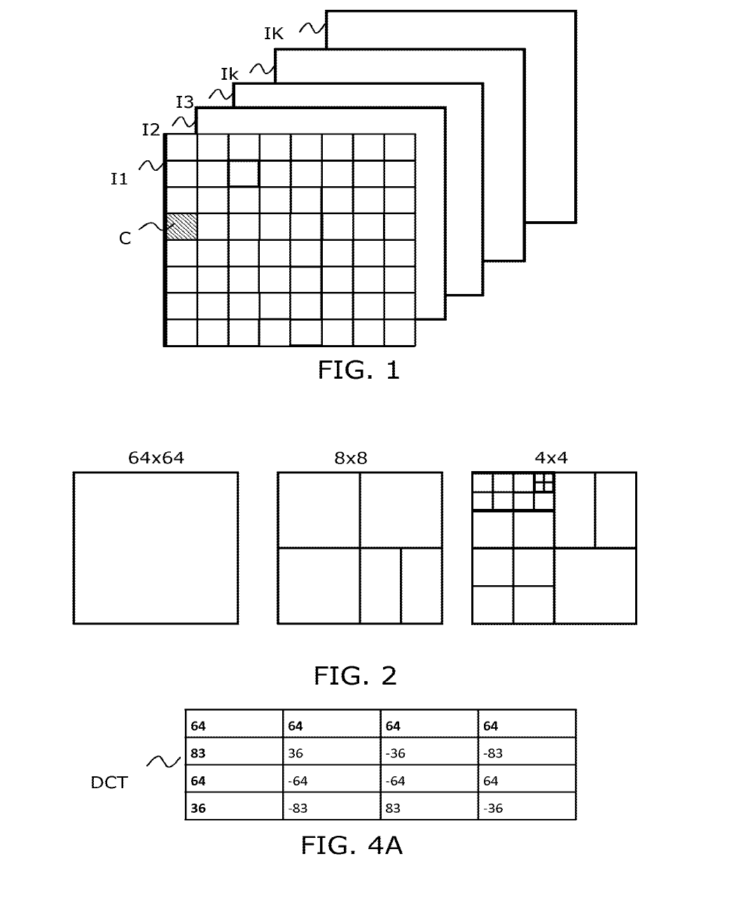

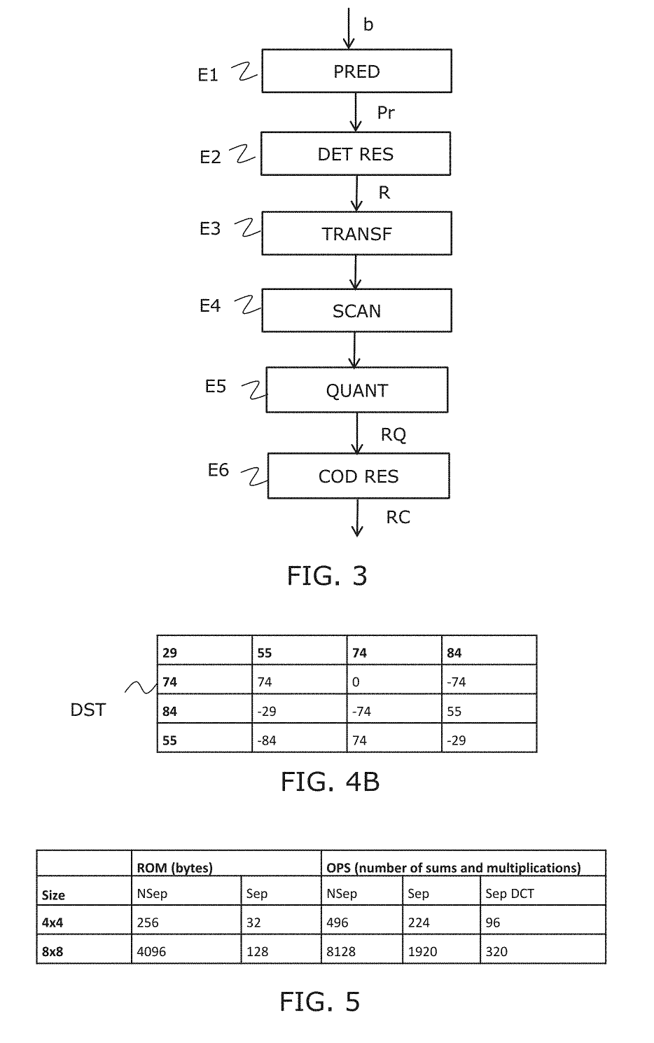

It is considered an original video consisting of a sequence of M images I1, 12, . . . IM with M non-zero integer, such as that shown in connection with FIG. 1. The images are encoded by an encoder, the encoded data is inserted a bit stream TB transmitted to a decoder via a communication network, or a compressed file FC, to be stored on a hard disk for example. The decoder extracts the encoded data, and then received and decoded by a decoder in a predetermined order known to the encoder and the decoder, for example in the temporal order I1, then I2, . . . , IM and then, the order may differ according to the embodiment.

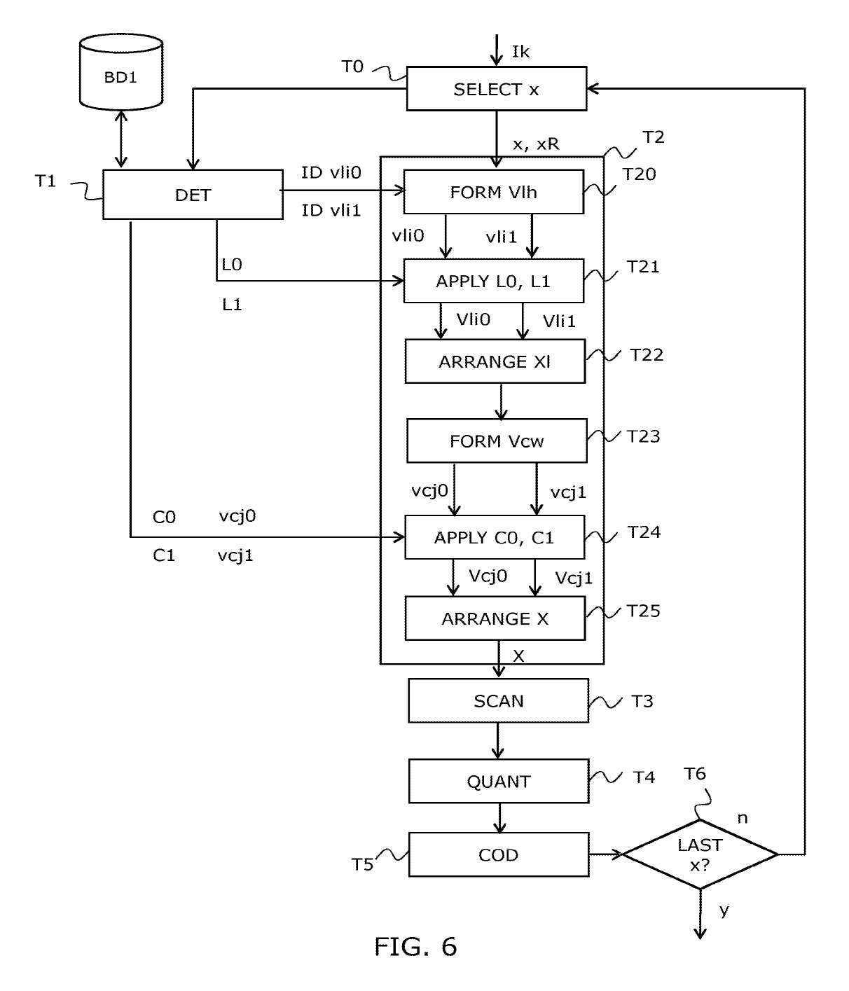

In relation to FIG. 6, we now consider the steps of an encoding method according to an embodiment of the invention.

During a step TO, a block to be processed, so-called current block x, is selected. For example, this is a CU, square or rectangular, block obtained by partitioning a block CTU.

Below, it is considered that the sizes of this block are a height H and a width W, which are non-zero integers. As an illustrative example, consider the special case of a W×H=4×4 block.

Let us consider a transformation step T2, wherein applying a transformation to the current block x. The step T2 of transforming the current block is separable and implemented in two sub-steps of linear transformation:

a first sub-step T21 of linear transformation applied to vectors VI0 to VIH of the block x, with size W, for providing an intermediate block XI comprising WxH coefficients;
a second sub-step T24 of linear transformation applied to vectors Vc0 to VcW-1 of the block XI, with size H, for providing the transformed block X.
   Note that, according to the invention, the first sub-step could equally well be applied to vectors Vc0 to VcW-1 of the block x and the second sub-step to vectors VI0 to VIH-1 of the block XI.

It is understood that for processing rectangular blocks, transforms of different sizes are caused to act on the lines and columns.

According to the invention, at least one of two transforming sub-steps T21, T24 is implemented from at least two distinct linear transformed, one being applied to at least one first vector of size equal to that a line of the block and formed in the block of pixels x or in the intermediate block of coefficients XI and the other to at least one second vector of size equal to that of a line of the block and formed in the same block. Upon completion of the sub-step(s) using two distinct linear transforms, one obtains the transformed vectors whose coefficients are rearranged in a block XI, X of size M×N in T22, T25.

In this regard, we note that there are different ways to rearrange the coefficients in a block and one used by the encoder must be known to the decoder. For this purpose, information representative of a mode of rearrangement of these coefficients may be encoded and transmitted to the decoder in the bit stream.

Alternatively, predetermined rearrangement rules will be shared by the encoder and the decoder.

Thus, the transformation T2 produces a block X including transformed coefficients, ready to be scanned by a scanning order in T3, quantized in T4 and coded in T5. Note that the steps T3 and T4 can be interchanged.

Upon completion of the processing of the current block, we test in T6 whether the current block x is the last block to be processed by the encoding unit, given the coding scanning order previously defined. If so, the encoding unit has completed its processing and the encoded data is inserted into a bit stream TB. If not, the next step is the step of selecting the next block T0. This block becomes the current block to be processed, and the next step is the prediction step T1, already described, of determining transforms to be applied to the current block.

The bit stream TB can then be transmitted to a decoder.

Various embodiments of the steps T1 of determining transforms T1 and of transforming T2, in particular the sub-steps T20, T23 of forming vectors, T21, T24 of applying transforms to the vectors formed and T22, T25 of arranging transformed coefficients in a block, will now be detailed.

According to a first embodiment of the invention, said at least two transforms are implemented during the first transforming sub-step T21.

For example, it is assumed that the first sub-step T21 implements transforms on vectors of size equal to that of a line of the current block x and that the second sub-step T24 implements at least one transform on vectors of size equal to that of a column and formed from elements of the intermediate block XI.

In this case, the method implements a preliminary step T20 of forming H vectors VI₀ to VI_{H-1} of length W from the pixels of the current block x.

Advantageously, these vectors are formed so that each element of the current block is used in a single vector.

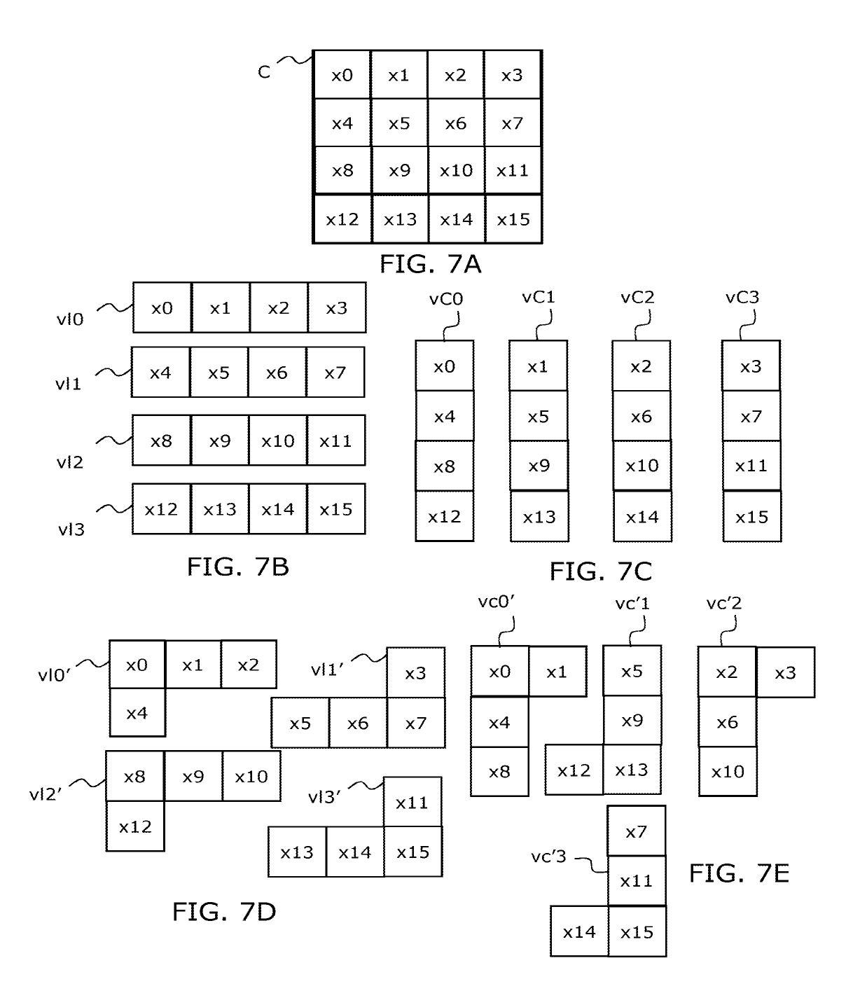

In connection with FIG. 7A, we consider by way of example a current block x of size 4×4. It includes 16 coefficients x0 to x15.

In connection with FIG. 7B, there is shown a first example of vectors VI0 to VI3 formed from the lines of block x. A vector VIh of this type corresponds to the line number h of the current block x.

In connection with FIG. 7D, there is shown a second example of vectors V′i0 to V′I3 formed from 4 elements, neighbouring between pairs, of the block x. These items do not originate from the same line. For example, the vector VI′0 comprises three consecutive elements x0, x1, x2 of the first line of the block and 1 element x4 of the second line of the block, neighbouring with the element x0 of the first line.

It is understood that this type of vector of size equal to that of a line can be advantageously used to monitor a texture discontinuity present in the block and better exploit the correlation between the elements of the vector.

The coding method according to the invention then implements a step T2 of determining of at least two distinct linear transforms L0, L1 to be applied to vectors VI0 to HIV-1 formed, at least one first transform L0 to be applied to at least a vector V1h1 formed and at least one second transform L1 to be applied to at least another vector V1h2r, with h1, h2 integers between 0 and H-1 and h1≠h2.

The differentiated transforms may be of the DCT or DST type or any other effective linear transform for encoding. Optimal transforms can thus be used for the correlation, i.e. KLT (for “Karhunen-Loeve Transform”), or optimised in a bit rate distortion criterion as presented in the article by Sezer et al., entitled “Robust learning of 2D separable transforms for next generation video coding”, published in the proceedings of the conference DCC (for “Data Compression Conference”) in 2011.

Advantageously, we determine said at least two linear transformations based on at least one encoding parameter of the current block, as for example the block size, or still the INTRA prediction mode selected.

For example, experiments conducted previously offline have identified at least two linear transformations adapted to a particular INTRA prediction mode and store the association obtained in memory.

Advantageously, the identifiers of linear transforms associated with a coding parameter value is stored in a coder memory. This is for example a database BD1 that includes entries associating an encoding parameter such as for example the prediction mode INTRA previously mentioned, an identifier of the first transform, at least one identifier or index vector of the block or of the intermediate block to which the first transform will be applied, and an identifier of at least one second transform, distinct from the first and at least one identifier or index of the second vector of said block to which the second transform will be applied.

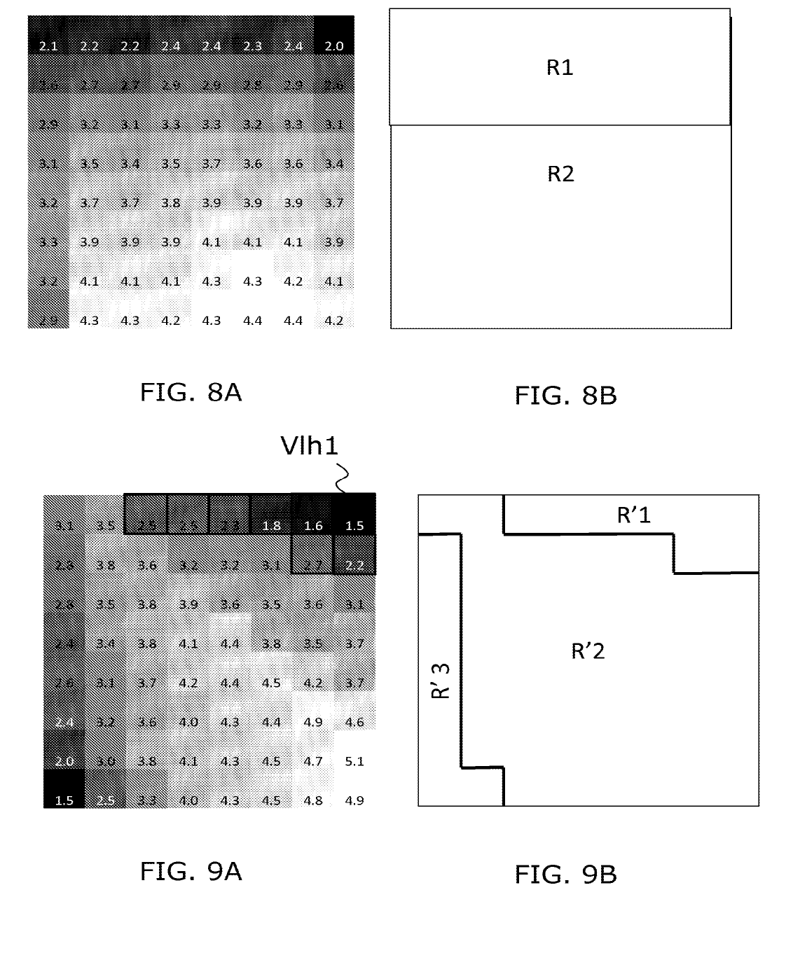

In connection with FIG. 8A, we have mean energy values estimated per pixel in residual blocks of size 8×8, from a given INTRA prediction mode, in this case the prediction mode number 26 according to the standard HEVC. Such an estimate is made offline.

It is noted that the energy per pixel has a horizontal stripe pattern which would justify cutting in two (or more) separate regions.

In relation to FIG. 8B, two regions R1, R2 are shown:
The first region R1 consists of the first three lines which have a constant pattern;
The second region R2 consists of the last five lines which have a less constant profile, due to the more marked discontinuity on the first column.

Advantageously, two transforms L1, L2 have been determined, one being applied to the line vectors of the region R1 and the other to the line vectors of the region R2.

Thus according to this prediction mode, the encoder applies a partition into two <<line>> transforms each sharing one region.

For the fairly homogeneous region R1, we have chosen a DCT-type transform or a transformation defined in the sense of the KLT. The DCT may be considered appropriate as it is suitable for the transformation of continuous patterns.

For the region R2, we chose a transform capable of taking account the greater discontinuity in the first column, for example, DST, or a transformation defined in the sense of the KLT. The DCT may be considered appropriate as it is adequate for the transformation of patterns with an initial discontinuity. For the region R2, we note that the mean energy of the first pixel on the left edge, has a value significantly different from that of other pixels energies.

Without memory constraint, we would define more regions, possibly as many as lines and we would use 8 transforms, at the cost of greater occupation of memory space.

Taking into account the memory occupancy constraint leads to reduced efficiency with a limited drop in performance.

According to the example of FIGS. 8A and 8B, an input associated with the prediction mode 26, the transform L0 for the line vectors vI0 to vI2 and the transform L1 for the column vectors vI3 to vI7.

In connection with FIG. 9A, we now present the mean energy, per pixel, obtained for a residual signal obtained by offline pre-analysis of blocks of size 8×8 from a given coding mode, in this case the mode of prediction 19 as defined by the HEVC standard. This prediction mode has an angle of approximately −53° and performs a diagonal prediction from top to bottom.

The energy variations between pixels delineate three zones R′1, R′2, R′3 shown in FIG. 9B. They should be cut in order to process them by three distinct transforms associated with the regions with R′1, R′2 and R′3 and adapted to their respective statistics.

In this example, we see that the regions formed do not correspond to one or more lines of the block. According to the invention, it is interesting to form vectors of sizes equal to that of a line, from neighbouring elements whereas all of them do not necessarily belong to the same line, according to the borders of the regions considered. For example, the vector V1h1 shown in FIG. 9A corresponds to the region R′1.

According to a first aspect, an input of the database BD1 associates with the prediction mode 19, an identifier of the transform L′0, an identifier of the vector(s) formed in the region R′1 and to which the transform L′0 should be applied, an identifier of the transform L′1, an identifier of the vector(s) formed in the region R′2 to which the transform L′2 should be applied, an identifier of the transform L′3, an identifier of the vector(s) formed in the region R′3 to which the transform the L′3 should be applied.

The coding method thus determines how to form the vectors of sizes equal to those of one line and determines the transforms to be applied to these vectors based on the prediction mode used, by reading the corresponding entry in the database BD1.

According to another aspect, the coding method further calculates a correlation between the values of the pixels residues to the current block at the end of the prediction based on the prediction mode INTRA number 19 and the pattern region R′1, R′2, R′3, which has just been presented.

In case of high correlation between these two quantities, that is to say a correlation above a set correlation threshold, the encoder decides to use the three transforms L′0, L′1, L′2.

The encoder applies the three transforms, adapted to different zones, with transforms adapted thereto. For example an adaptation in the sense of the KLT is performed.

It indicates this choice by inserting the decoder in the bit stream coded information representative of a pattern indicator associated with the INTRA prediction mode number 19.

It is understood that, according to this embodiment, the database BD1 potentially includes multiple entries corresponding to the same encoding parameter, each entry comprising a distinct pattern indicator associated with different vectors and different transforms.

Upon reception of the prediction mode information and of the pattern selected by the encoder, the decoder reads in its database BD2 the identifiers of the vectors to be formed in the block and of the transforms to be applied to them. It then performs the inverse transformations of those performed at the encoder.

Alternatively, the linear transforms are determined dynamically by pre-analysis of the current block to be encoded. For example, this pre-analysis implements known contours analysis techniques using an estimate of the gradient. Contour detection is then exploited to determine at least two regions and to assign types of transforms to them, depending on their characteristics, for example the homogeneity of their texture. In this case, the identifiers of the determined linear transforms and the identifiers of the relevant vectors are signaled in the bit stream and transmitted to the decoder.

Alternatively, such contour analysis is conducted on one or more neighbouring blocks already processed and combined with a continuity assumption over the current block, for example according to an orientation of the contour in the next block, in relation to the current block.

When a contour continuity decision is made, the regions of the current block are then determined based on those of the neighbouring block already processed.

In this case, the encoder signals to the decoder the neighbouring block from which the regions, i.e. the vectors and the transforms to be used, must be inherited, based on coded information representative of an inheritance mode with respect to the neighbouring block affected. It should be understood that the decoder will be required to implement the same contour analysis on the same neighbouring block, once decoded, to deduce therefrom the vectors, i.e. the transforms to be used.

According to an embodiment variation of the invention, said at least two distinct linear transforms are implemented during the second transforming sub-step T31.

In this case, vectors of size H, equal to that of columns of the current block, are formed at T11, following the first transforming sub-step T30, from the coefficients of the intermediate block XI. W vectors Vc0 to VcW-1, of length H, are obtained.

As above, several types of vectors of size H can be formed.

In relation to FIG. 7C, the vector VCW corresponds to the column number w of the block.

In relation to FIG. 7E, the vector Vc′w comprises elements from two adjacent columns.

The determining step T′2 has provided at least two distinct linear transforms C0, C1 to be applied to the vectors Vc0 to VcW-1 formed.

The various embodiments of the steps of forming the vectors VI0 to VIH-1 and of determining the linear transforms Li presented above, can be transposed to the steps of forming the vectors Vc0 to VcW-1 and of determining the linear transforms Cj, bearing in mind that they are implemented for the intermediate block XI.

Advantageously, the principle of the invention is implemented in the two transforming sub-steps T30 and T31. In this case, the encoding method implements the first step T10 of forming the vectors VI0 to VIH-1 of size W from the current block X, a first step T20 of determining the transforms L0, L1 to be applied to the vectors VI0 to VIH-1, the second step T11 of forming the vectors Vc0 to VcW-1 of size H from the intermediate block XI and a second step T21 of determining the transforms C0, C1 to be applied to the vectors Vc0 to VcW-1.

One advantage is to better exploit the statistical characteristics of the different vectors formed, for the two transforming sub-steps. Of course, this embodiment requires on the other hand to store a larger number of transforms.

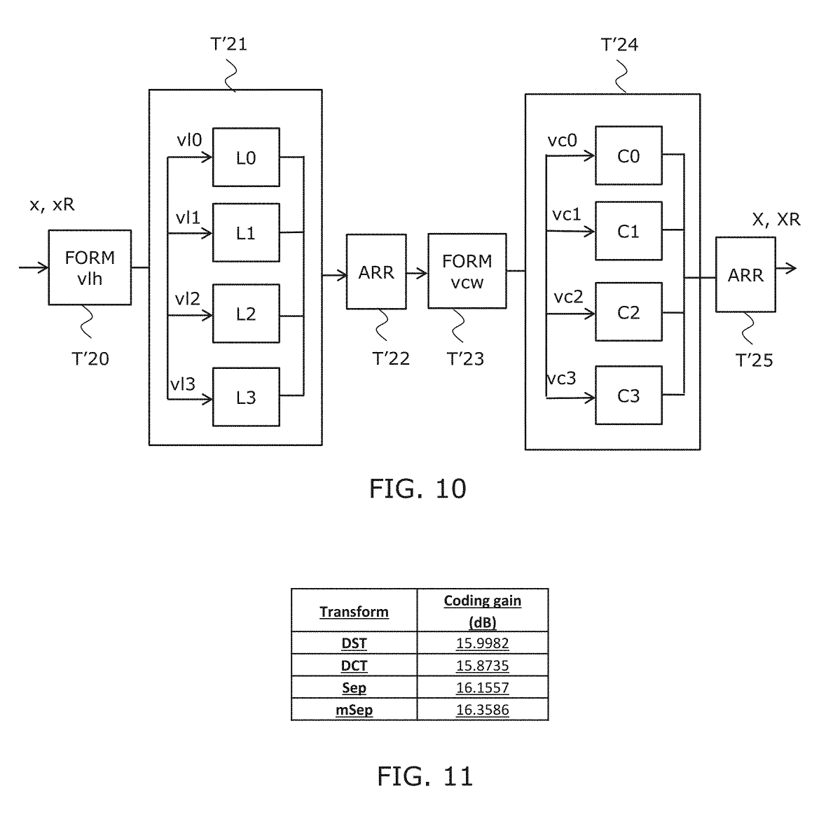

In relation to FIG. 10, a method for encoding a digital image according to a second embodiment of the invention is now illustrated.

According to this embodiment, we consider H lines transforms L0 to LH-1 and W columns transforms C0 to CW-1. In other words, a linear transform specific to each vector formed is applied in the current block, regardless whether the vectors VI0 to VIH-1 of size W formed at T′20, or the vectors Vc0 to VcW-1, of size H, formed in T′23.

As an illustrative example, let us consider the case of a 4×4 block.

The signal XI transformed during the step T′21, is obtained by concatenation of the following operations:

$$[ \begin{matrix}{Xl}_{0} \\ {Xl}_{1} \\ {Xl}_{2} \\ {Xl}_{3}\end{matrix} ] = {L}_{0} \cdot [ \begin{matrix}{x}_{0} \\ {x}_{1} \\ {x}_{2} \\ {x}_{3}\end{matrix} ] \\ [ \begin{matrix}{Xl}_{4} \\ {Xl}_{5} \\ {Xl}_{6} \\ {Xl}_{7}\end{matrix} ] = {L}_{1} \cdot [ \begin{matrix}{x}_{4} \\ {x}_{5} \\ {x}_{6} \\ {x}_{7}\end{matrix} ] \\ [ \begin{matrix}{Xl}_{8} \\ {Xl}_{9} \\ {Xl}_{10} \\ {Xl}_{11}\end{matrix} ] = {L}_{2} \cdot [ \begin{matrix}{x}_{8} \\ {x}_{9} \\ {x}_{10} \\ {x}_{11}\end{matrix} ] \\ [ \begin{matrix}{Xl}_{12} \\ {Xl}_{13} \\ {Xl}_{14} \\ {Xl}_{15}\end{matrix} ] = {L}_{3} \cdot [ \begin{matrix}{x}_{12} \\ {x}_{13} \\ {x}_{14} \\ {x}_{15}\end{matrix} ]$$

The L₀, L₁, L₂ and L₃ represent the lines transforms and are therefore matrices of size 4×4 in this embodiment, which can potentially be implemented as a fast algorithm, based on a butterfly decomposition as known in the literature, particularly if the transforms used are of DCT/DST-type.

The 16 transformed coefficients (XI₀ . . . XI₁₅) can thus be obtained from the 16 (x₀ . . . x₁₅) pixels of the initial block x. They are rearranged in T′22 to form the block XI, for example by considering that each vector VIi transformed by the linear transform Li has helped form the line i of the block XI.

The column transformation is applied at T′24 similarly as follows:

$$[ \begin{matrix}{X}_{0} \\ {X}_{1} \\ {X}_{2} \\ {X}_{3}\end{matrix} ] = {C}_{0} \cdot [ \begin{matrix}{Xl}_{0} \\ {Xl}_{4} \\ {Xl}_{8} \\ {Xl}_{12}\end{matrix} ] \\ [ \begin{matrix}{X}_{4} \\ {X}_{5} \\ {X}_{6} \\ {X}_{7}\end{matrix} ] = {C}_{1} \cdot [ \begin{matrix}{Xl}_{1} \\ {Xl}_{5} \\ {Xl}_{9} \\ {Xl}_{13}\end{matrix} ] \\ [ \begin{matrix}{X}_{8} \\ {X}_{9} \\ {X}_{10} \\ {X}_{11}\end{matrix} ] = {C}_{2} \cdot [ \begin{matrix}{Xl}_{2} \\ {Xl}_{6} \\ {Xl}_{10} \\ {Xl}_{14}\end{matrix} ] \\ [ \begin{matrix}{X}_{12} \\ {X}_{13} \\ {X}_{14} \\ {X}_{15}\end{matrix} ] = {C}_{3} \cdot [ \begin{matrix}{Xl}_{3} \\ {Xl}_{7} \\ {Xl}_{11} \\ {Xl}_{15}\end{matrix} ]$$

The C₀, C₁, C₂ and C₃ represent the columns transforms and are therefore matrices of size 4×4 in this embodiment, which can potentially be implemented as a fast algorithm, based on a butterfly decomposition as known in the literature, particularly if the transforms used are of DCT/DST-type.

Thus in the embodiment on the block 4×4 that has just been presented above, 8 transforms were provisioned.

An advantage of this embodiment is to take into account the fact that each line and each column individually presents their own statistics. The compression performance is improved.

In relation to FIG. 11, there is illustrated the gain provided by the use of multiple transforms in a specific case, that of the INTRA coding at HEVC, for blocks of size 4×4.

In this context, HEVC uses for blocks of size 4×4, a line and column transform of type DST VII, this transformation has shown the best results in terms of compactness of the signal.

This takes place in the context of an intra prediction number 18. This prediction is diagonal. To evaluate the performance of a transformation, we measure its coding gain, that is to say the ratio between the energy of the signal and the geometric mean of the transformed coefficients.

In relation to the table in FIG. 11, we present the performances obtained with the DST as used in HEVC, the DCT commonly used in image/video encoding, an optimal separable transform in the sense of KLT (designated Sep in the table) and a set of transforms according to the invention, optimised in the sense of KLT (designated mSEP in the table).

Optimisation in the sense of KLT consists in finding lines and columns transformations that provide the best coding gain. According to prior art, the KLT transformations are obtained by taking into consideration pixels to pixels correlations of the vectors to be transformed and determining the transformation which decorrelates at best these pixels. The autocorrelation matrix of the pixels is thus determined, and then a diagonalisation is performed: the proper vectors generating the decorrelation form the transform KLT.

These results demonstrate improved performance using the invention or a significant gain is noticed over the methods of the prior art.

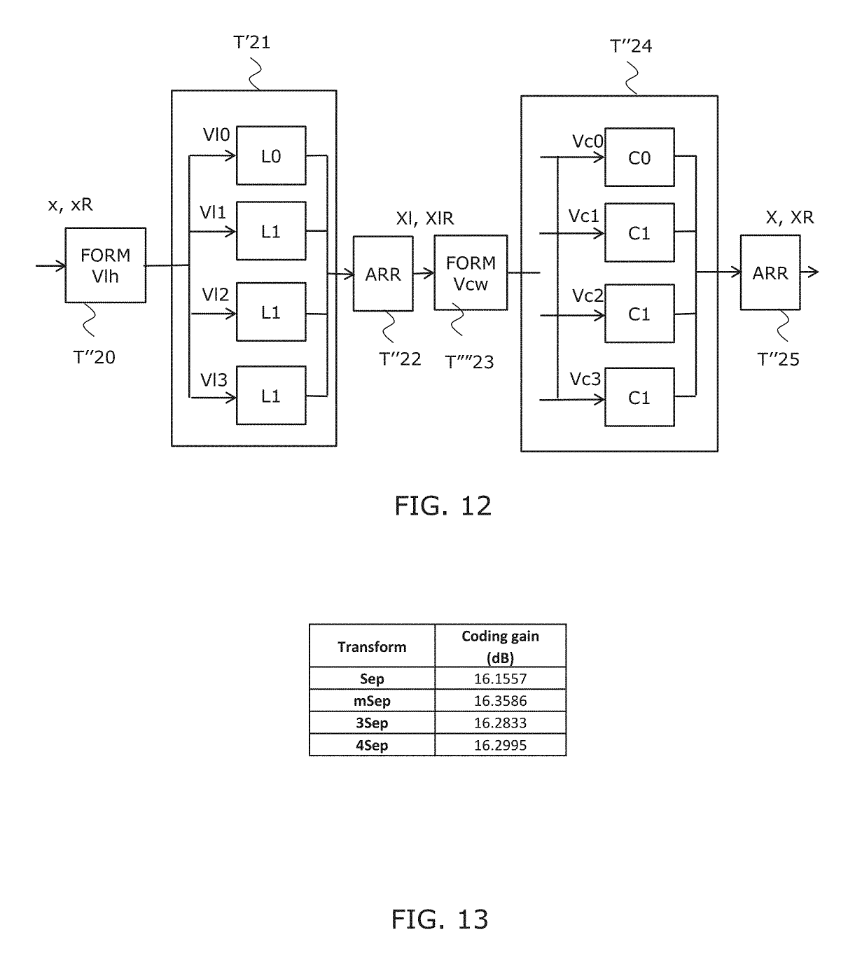

In relation to FIG. 12, a method for encoding a digital image according to a third embodiment of the invention is now illustrated.

According to this embodiment is formed of the “line” vectors at T″20 from the block of pixels x and two separate lines transforms are applied to them during the first sub-step T″21. The coefficients obtained are rearranged at T″22 to form an intermediate block XI, “column” vectors are formed at T″23 and two distinct columns transforms are applied to them during the second transformation sub-step T″24. The transformed coefficients are rearranged at T″25 to form the transformed block X.

Thus the line transformation implemented by the first sub-step T″21 differentiates the transformation for the first line from that used for the others and can be expressed as follows, for a block of size 4×4:

$$[ \begin{matrix}{Xl}_{0} \\ {Xl}_{1} \\ {Xl}_{2} \\ {Xl}_{3}\end{matrix} ] = {L}_{0} \cdot [ \begin{matrix}{x}_{0} \\ {x}_{1} \\ {x}_{2} \\ {x}_{3}\end{matrix} ] \\ [ \begin{matrix}{Xl}_{4} \\ {Xl}_{5} \\ {Xl}_{6} \\ {Xl}_{7}\end{matrix} ] = {L}_{1} \cdot [ \begin{matrix}{x}_{4} \\ {x}_{5} \\ {x}_{6} \\ {x}_{7}\end{matrix} ] \\ [ \begin{matrix}{Xl}_{8} \\ {Xl}_{9} \\ {Xl}_{10} \\ {Xl}_{11}\end{matrix} ] = {L}_{1} \cdot [ \begin{matrix}{x}_{8} \\ {x}_{9} \\ {x}_{10} \\ {x}_{11}\end{matrix} ] \\ [ \begin{matrix}{Xl}_{12} \\ {Xl}_{13} \\ {Xl}_{14} \\ {Xl}_{15}\end{matrix} ] = {L}_{1} \cdot [ \begin{matrix}{x}_{12} \\ {x}_{13} \\ {x}_{14} \\ {x}_{15}\end{matrix} ]$$

So we now only have two transforms (L₀ and L₁) rather than 4 before.

For columns, one can proceed analogously, that is to say keep only 2 transforms to differentiate the columns (for example of first of the following ones). It is also possible in an embodiment to keep only a single transformation for the set of columns, or in another embodiment retain the 4 distinct transformations as outlined in the first embodiment.

Thus the impact related to the storage of the transforms is significantly reduced.

To illustrate the performance obtained by the third embodiment for a memory reduction, the coding gains achieved with the blocks 4×4 are again illustrated for the prediction 18 of the intra mode of HEVC.

Two distinct transformations are kept for the lines and the columns. We thus have 4 transformations in total instead of 8 as shown in the first embodiment (note that configuration 4Sep).

Alternatively, two distinct transformations are kept for the lines and only one transform for columns (for columns, we are close to the state of the art). We thus have 3 transformations in total instead of 8 as shown in the first embodiment (note that configuration 3Sep).

The results are shown in the table of FIG. 13.

It is therefore obvious that these versions, with a reduced memory, enable to come closer to the results obtained by the version with 8 transforms (mSep) with half or less of memory used. There remains a significant advantage in terms of compression with respect to the transforms of the state of the art.

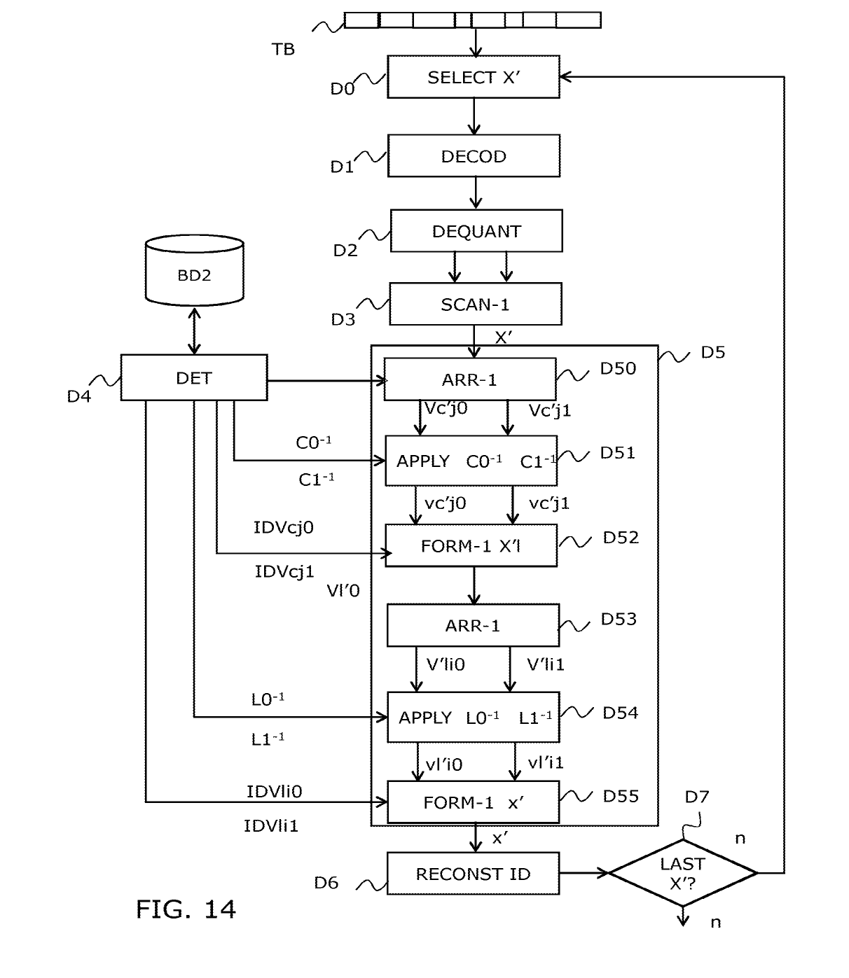

In relation to FIG. 14, we now consider the steps of a decoding method according to an embodiment of the invention.

Let us assume that a bit stream TB was received by a decoding device implementing the decoding method according to the invention.

At D0, we first select the first block to be processed as the current block C′. For example, this is the first block (in lexicographic order). This block contains M×N pixels, where M and N are non-zero integers.

As described for the encoding process, the block C′ considered can be a block CTU or a sub-block CU obtained by cutting the block CTU or a block or residue sub-block obtained by subtracting a prediction from the current block to the current block.

In a step D1, the coded data relating to the current block C′ is read and decoded. In D2, the decoded data relating to the current block C′ is dequantised. We obtain a vector of dequantized coefficients DQ [k], k is an integer from 0 to M×N−1.

During a step D3, the coefficients of the vector DQ are arranged in a transformed block X′. This is the reverse operation of the course T3 implemented by the encoding method.

In D4, the transforms to be applied to the current block X′ during the successive sub-steps D51, D54 of inverse transformation are determined. According to the invention, one of them implements at least two distinct linear transforms. It will be understood that these transforms are inverse to those used by the coding method according to the invention.

At the decoder, the inverse transforms to be applied to vectors of size equal to that of a line, respectively of a column can be determined in various ways, among which the following may be mentioned by way of example:
by reading in the identification information bit stream TB of at least one first transform and one second transform;
by reading identification information of the transforms used by the encoder in a local or remote memory;

Advantageously, the choice of the first and second transform may be associated with an encoding parameter of the current block, for example its size or its prediction mode.

According to one embodiment of the invention, the transforms to be applied are obtained by reading a memory, for example the entry of a database BD2 associating an encoding parameter, an identifier of the first transform to least one identifier of the first vector of the block or of the intermediate block, an identifier of at least one second transform, distinct from the first to at least one identifier of a second vector of said block.

Advantageously, during D4, we have also determined how the vectors were formed in the current block at the encoder. For example the vector identifier corresponds to a known type of vector formed in a block of size M×N.

It will be understood that the decoder needs to know how to form the vectors in the same way as the encoder. Several types of column or lines vectors can be formed. Similar to what was described for the various transforms to be applied, several embodiments are contemplated, including:
The decoder locally has the same rules to form the vectors as the encoder. For example, these rules are stored in memory;
Advantageously, the decoder accesses information stored in a database comprising entries associating with an encoding parameter, indications enabling the formation of H vectors of size W and of W vectors of size H in the current block. This database is duplicated at the level of the encoder and the decoder;
The decoder extracts from the bit stream information representative of a type of vector formed by the encoder. This variation is particularly advantageous, when the type of vector formed is chosen dynamically, on the basis of a pre-analysis of the content of the current block implemented at the level of the encoder.

Upon completion of this step, we therefore know the number, the indices and the types of vectors associated with a linear transform identifier.

In the following description, it is assumed that during encoding, the first sub-step implemented at least two transforms of vectors of size equal to that of a line and the second sub-step implemented one or several transforms on vectors of size equal to that of a column.

At decoding, the inverse operations will be conducted in reverse order of that performed during encoding. In this exemplary embodiment, the first sub-step D51 of inverse transformation thus applies to vectors of size equal to that of a column.

During a step D50, vectors with coefficients of length equal to that of one column of the block X′ are formed in the block X′. This is the inverse operation of the arrangement operation T25 of the coefficients of the transformed vectors in a block X implemented by the encoding method.

For example, on the encoder side, the coefficients of the column vector Vcj transformed by a linear transform C0, C1 or Cj of the step T24, had simply been positioned in the column j of the block X. In step D50 of the decoding method, on the contrary, a vector V′cj of length equal to that of a column is formed from the coefficients in column j of the block X′. It is therefore understood that in this example, a column of X′ comprises the coefficients from the linear transformation applied by the coding method to the associated vector vcj. In this simple case, the step D50 then simply consists in forming “columns” vectors V′cj from the columns of the block X′.

Advantageously, the step D50 is based on information relating to this rearrangement obtained during the determining step D4. For example, rearrangement which consists in associating the column cj0 at the entry of the linear transform C0⁻¹ and the column cj1 at the entry of the linear transform C1⁻¹ is indicated by information representative of a type of predetermined rearrangement or associates vectors identifiers with each linear transform.

Such vector identifiers advantageously comprise one type of vector and a vector index. For example, the type of vector considered is the column type and the vector to be formed is the number j, that is to say the one which corresponds to the column j of the block.

At D51, the linear inverse transforms C0⁻¹, C1₋₁ are applied to the vectors V′cj0, V′cj1 formed at D50, e.g. the columns cj0, cj1 in a transposed formed if they are orthogonal or using a fast algorithm.

Vectors v′cj0, v′cj1 are obtained.

During a step D52, the coefficients of the vectors v′cj0, v′cj1 processed are positioned to form an intermediate block X′I. To do this, we use the identification information of the vectors determined at step D4 and relative to the formation of the vectors on the encoder side, before proceeding to the opposite operation.

For example, if the vectors are columns vectors, the identification information includes a column index and the elements of the vectors are placed in the corresponding column.

If the vectors are not linear, the identification information identifying a type of nonlinear vector known to the decoder, which can position the elements in the block M×N. For example, if the information identifying the determined indicate that the vector vcj formed in the block X′I, on the encoder side, was of the type of those described in connection with FIG. 7E, with an index corresponding to the vector vc0, then the coefficients will be placed in X′1, X′0, X′4, X′8.

Before being subjected to the second sub-step of inverse transformation D54, the resulting intermediate block X′I is then implemented in a forming step D53, similar to step D50, but which forms a vector V′Ii in the block X′I from the rearrangement information obtained by D4, and associates thereto one of the linear transforms LO⁻¹ and L1⁻¹ also determined in D4.

At D54, the inverse transforms are applied, in a transposed form, if they are orthogonal or use a fast algorithm, and produce vectors V′IiO, V′Ii1 of size equal to that of a line. The operations implemented by the decoder according to the invention are similar to those used by the state of the art: the complexity is hence unchanged for performing the transformations.

At D55, the vectors obtained are positioned to form the block of pixels x′. This is the reverse operation of that of forming T20 vectors implemented in the coding method according to the invention.

At D6, the block of pixels of the decoded image from the block x′ obtained are rebuilt and this block is integrated to the ID picture being decoded. If the block x′ is a residue block, a prediction of the current block obtained from a reference image previously processed will be added to said block.

During a step D7, we test whether the current block is the last block to be processed by the decoding unit, given the route order previously defined. If so, the decoding process has completed its processing. If not, the next step is the step of selecting the next block DO and the decoding steps D1 to D7 described above are repeated for the next block selected.

It will be noted that the invention just described, can be implemented using software and/or hardware components. In this context, the terms “module” and “entity” used in this document, can be either a software component or a hardware component or even a set of hardware and/or software, capable of implementing the functions outlined for the module or entity concerned.

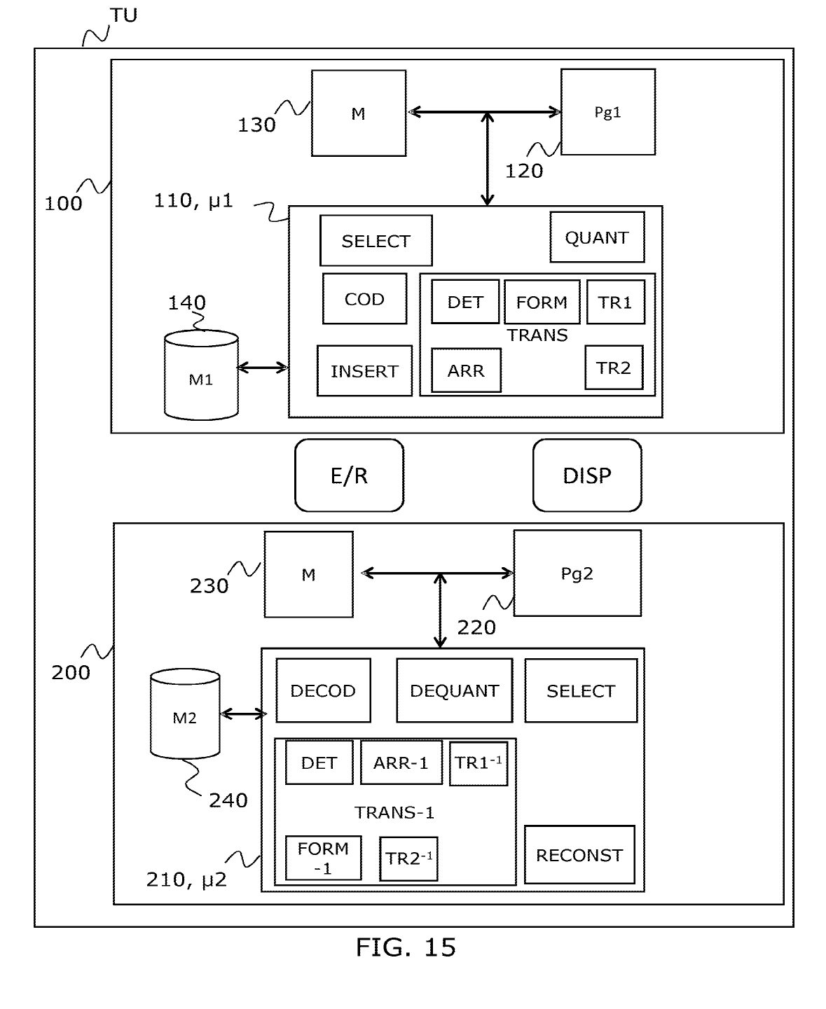

In relation to FIG. 15, we now present an example of simplified structure of an encoding device 100 of a digital image according to the invention. The device 100 implements the encoding method according to the invention which has just been described in connection with FIG. 6.

For example, the device 100 comprises a processing unit 110, equipped with a processor p1 and driven by a computer program Pg1 120 stored in a memory 130 and implementing the method according to the invention.

At initialisation, the computer program code instructions Pg₁ 120 are for example loaded into a RAM before being executed by the processor of the processing unit 110. The processor of the processing unit 110 implements the method steps described above, according to the instructions of the computer program 120.

In this embodiment of the invention, the device 100 comprises at least one unit TRANS for transforming a current block into a transformed block X comprising a first sub-unit TR1 for transforming the current block into an intermediate block and a second sub-unit TR2 for transforming the intermediate block into the transform block, a unit QUANT for quantizing the transformed block, a unit COD for coding the quantized block and a unit INSERT for inserting encoded data into the bit stream TB.

According to the invention, the transformation comprises at least one sub-unit FORM for forming at least two vectors from elements (pixels, respectively coefficients) of one of said blocks among the current block and the intermediate block, adapted to be implemented prior to at least one of said transformation sub-units and a sub-unit ARR for arranging obtained coefficients in a block. The device also comprises a unit DET for determining at least two distinct transforms to be applied to said vectors at least based on a coding parameter of the current block.

Advantageously, the device 100 further comprises a memory, for example a unit BD1 for storing a table comprising entries associating with an encoding parameter an identifier of the first transform with at least one identifier of the vector of the block or of the intermediate block, an identifier of at least one second transform, distinct from the first one, with at least one identifier of the second vector of said block.

These units are controlled by the processor μ1 of the processing unit 110.

Advantageously, such a device 100 can be integrated into a user terminal TU. The device 100 is then arranged to cooperate at least with the next module of the terminal TU:
a E/R module for sending and receiving data via which the bit stream TB or the compressed file FC is transmitted via a telecommunications network to a decoding device;

For example, the decoding device 200 comprises a processing unit 210, equipped with a processor μ2 and driven by a computer programme Pg2 220 stored in a memory 230 and implementing the decoding method according to the invention, which has just been described in connection with FIG. 14.

At initialisation, the computer program code instructions Pg2 220 are for example loaded into a RAM before being executed by the processor of the processing unit 210. The processor of the processing unit 210 implements the steps of the method described above, according to the instructions of the computer programme 220.

In this embodiment of the invention, the device 200 comprises at least one unit DEC for decoding the coefficients of current block transformed from data read in the bit stream, a unit DEQUANT for dequantizing the decoded coefficients, a unit TRANS⁻¹ for inverse transforming the transformed current block, adapted to implement two successive inverse transformation sub-units, the first subunit TR1⁻¹ being applied to the current transformed block, the second TR2⁻¹ to the intermediate block, resulting from the first sub-unit. According to the invention, at least one of the sub-units TR1⁻¹, TR2⁻¹ implements at least a first and a second linear transform, distinct from one another, on a so-called block to be processed, among the current block transformed and the intermediate block.

According to the invention, the inverse transforming unit further comprises a sub-unit FORM⁻¹ adapted to rearrange the coefficients of the vectors processed by the first and second transforms in the processed block.

Advantageously, the device also comprises a unit ARR-C1 for forming at least two vectors from the coefficients of the block to be processed, said vectors having a length equal to one of the sizes of the current block, to which the first and second linear transforms will be applied and a unit DET for determining at least two distinct linear transforms to be applied to said vectors at least based on a coding parameter of the current block.

These units are controlled by the processor μ2 of the processing unit 210.

Advantageously, such a device 200 can be integrated into a user terminal TU. The device 200 is then arranged to cooperate at least with the next module of the terminal TU:
a module E/R for sending and receiving data via which the bit stream TB or the compressed file FC is received from a telecommunications network;
A device DISP for generating images, for example a terminal monitor, via which the decoded digital image or the series of decoded images is presented to a user.

Advantageously, the user terminal TU may include both an encoding device and a decoding device according to the invention.

An exemplary embodiment of the present disclosure overcomes the shortcomings of the prior art.

An exemplary embodiment proposes a solution that improves the compression performance of a digital image encoder, without requiring a significant increase in computation and memory resources.

It goes without saying that the embodiments which have been described above have been given by way of purely indicative and non-limiting example, and that many modifications can be easily made by those skilled in the art without departing from the scope of the invention.

1. A method for encoding comprising:
encoding a digital image with an encoding device, said image being divided into a plurality of blocks of pixels processed in a defined order, said encoding comprising the following steps, implemented for a current block, of predetermined sizes:
transforming the current block into a transformed block, said transformed block comprising coefficients, said step implementing two successive transformation sub-steps, the first sub-step being applied to the current block and the second sub-step to an intermediate block, resulting from the first sub-step, said intermediate block comprising coefficients, and
quantizing and encoding the coefficients of the transformed block,
said transforming step further comprising, prior to at least one of said transformation sub-steps, said sub-step being applied to a block, called a block to be transformed, among the current block and the intermediate block, a preliminary sub-step of forming at least a first and a second distinct vectors, in the block to be transformed, the first and second vectors comprising the pixels or the coefficients of a sequence of pixels or adjacent coefficients of the block to be transformed, of length equal to one of the sizes of the block to be transformed; and
said at least one transforming sub-step comprising applying a first transform to said at least one first vector and at least one second transform distinct from the first, to said at least one second vector of said block.

2. The method for encoding a digital image according to claim 1, wherein the method further comprises a preliminary step of determining the at least two distinct transforms to be applied to said vectors, at least based on a coding parameter of the current block.

3. The method for encoding a digital image according to claim 1, wherein the determining step comprises reading information stored in a non-transitory computer-readable memory, said information comprising at least the coding parameter, an identifier of the first transform, at least one identifier of the first vector of the block or of the intermediate block, an identifier of at least one second transform, distinct from the first and at least one second vector identifier of said block.

4. The method for encoding a digital image according to claim 1, wherein said transforming step comprises a sub-step of rearranging the coefficients of the transformed vectors in the intermediate, and respectively transformed block.

5. The method for encoding a digital image according to one claim 1, comprising the following steps:
predicting values of the current block from at least one block previously processed according to a mode of prediction selected among a plurality of predetermined modes,
calculating a residual block by subtracting the predicted values from the original values of the current block,
wherein the transforming step is applied to the residual current block and said at least one coding parameter is the prediction mode of the current block.

6. The method for encoding a digital image according to claim 1, comprising a step of identification information coding of said at least one first transform and of said at least one second transform.

7. The method for encoding a digital image according to claim 1, wherein the first transform is applied to a first sub-set of vectors of size equal to that of a line, respectively to that of a column of the block and said at least one second transform is applied to a second sub-set of vectors of size equal to that of a line of the block, respectively to that of a column of said block.

8. The encoding method of a digital image according to claim 1, wherein said at least one transforming sub-step implements a distinct transform per vector of size equal to that of a line of the block, respectively to that of a column, formed in the block.

9. A device for encoding a digital image, said image being divided into a plurality of blocks of pixels processed in a defined order, said device comprising:
a processor; and
a non-transitory computer-readable medium comprising instructions stored thereon that when executed by the processor configure the processor to perform acts comprising:
encoding a digital image, comprising the following steps, implemented for a current block, of predetermined sizes:
transforming the current block into a transformed block, said transformed block comprising coefficients, said step implementing two successive transformation sub-steps, the first sub-step being applied to the current block and the second sub-step to an intermediate block, resulting from the first sub-step, said intermediate block comprising coefficients, and
quantizing and encoding the coefficients of the transformed block,
said transforming step further comprising, prior to at least one of said transformation sub-steps, said sub-step being applied to a block, called a block to be transformed, among the current block and the intermediate block, a preliminary sub-step of forming at least a first and a second distinct vectors, in the block to be transformed, the first and second vectors comprising the pixels or the coefficients of a sequence of pixels or adjacent coefficients of the block to be transformed, of length equal to one of the sizes of the block to be transformed; and
said at least one transforming sub-step comprising applying a first transform to said at least one first vector and at least one second transform distinct from the first, to said at least one second vector of said block.

10. A method for decoding, comprising:
decoding with a decoding device a digital image from a bit stream comprising encoded data representative of said image, said image being divided into a plurality of blocks of pixels processed in a defined order, said method decoding comprising the following steps, implemented for a block, called a transformed block:
decoding the coefficients of the transformed current block from data read in the bit stream;
dequantizing the decoded coefficients;
inverse transforming the current transformed block, said inverse transforming implementing two successive inverse transformation sub-steps, the first sub-step (D51) being applied to the current block, and the second sub-step to an intermediate block, resulting from the first sub-step;
wherein said at least one inverse transforming sub-step being applied to a block, called a block to be processed, from the current transformed block and the intermediate block, comprises applying a first inverse transform to at least one first vector of a length equal to that of one line or one column of the block to be processed and at least one second inverse transform distinct from the first, to at least one second vector of said block of length equal to that of one line or one column, respectively; and
a sub-step of forming the processed block, by positioning sequences of adjacent coefficients, respectively adjacent pixels of lengths equal to that of a column respectively a line, from the processed vectors.

11. The method for decoding a digital image according to claim 10, wherein decoding further comprises a preliminary step of determining the at least two distinct transforms to be applied to said vectors, at least based on a coding parameter of the current block.

12. The method for decoding according to claim 10, wherein the inverse transforming step further comprises a sub-step, prior to said at least one transforming sub-step, of rearranging sequences of adjacent coefficients of the block to be processed in said first and second vectors, such a sequence having a length equal to one of the size of the block to be processed.

13. A device for decoding a digital image from a bit stream comprising encoded data representative of said image, said image being divided into a plurality of blocks of pixels processed in a defined order, said device comprising:
a processor; and
a non-transitory computer-readable medium comprising instructions stored thereon that when executed by the processor configure the processor to perform acts comprising:
decoding the digital image, comprising the following steps, implemented for a block, called a transformed block
decoding with a decoding device a digital image from a bit stream comprising encoded data representative of said image, said image being divided into a plurality of blocks of pixels processed in a defined order, said decoding comprising the following steps, implemented for a block, called a transformed block:
decoding the coefficients of the transformed current block from data read in the bit stream;
dequantizing the decoded coefficients;
inverse transforming the current transformed block, said inverse transforming implementing two successive inverse transformation sub-steps, the first sub-step (D51) being applied to the current block, and the second sub-step to an intermediate block, resulting from the first sub-step;
wherein said at least one inverse transforming sub-step being applied to a block, called a block to be processed, from the current transformed block and the intermediate block, comprises applying a first inverse transform to at least one first vector of a length equal to that of one line or one column of the block to be processed and at least one second inverse transform distinct from the first, to at least one second vector of said block of length equal to that of one line or one column, respectively; and
a sub-step of forming the processed block, by positioning sequences of adjacent coefficients, respectively adjacent pixels of lengths equal to that of a column respectively a line, from the processed vectors.

14. (canceled)

15. A user terminal comprising the device for encoding a digital image according to claim 9.

16. A non-transitory computer-readable medium comprising instructions stored thereon, which when executed by a processor of an encoding device configure the encoding device to perform acts comprising:
encoding a digital image with an encoding device, said image being divided into a plurality of blocks of pixels processed in a defined order, said encoding comprising the following steps, implemented for a current block, of predetermined sizes:
transforming the current block into a transformed block, said transformed block comprising coefficients, said step implementing two successive transformation sub-steps, the first sub-step being applied to the current block and the second sub-step to an intermediate block, resulting from the first sub-step, said intermediate block comprising coefficients, and
quantizing and encoding the coefficients of the transformed block,
said transforming step further comprising, prior to at least one of said transformation sub-steps, said sub-step being applied to a block, called a block to be transformed, among the current block and the intermediate block, a preliminary sub-step of forming at least a first and a second distinct vectors, in the block to be transformed, the first and second vectors comprising the pixels or the coefficients of a sequence of pixels or adjacent coefficients of the block to be transformed, of length equal to one of the sizes of the block to be transformed; and
said at least one transforming sub-step comprising applying a first transform to said at least one first vector and at least one second transform distinct from the first, to said at least one second vector of said block.

17. A non-transitory computer-readable medium comprising instructions stored thereon, which when executed by a processor of a decoding device configure the encoding device to perform acts comprising:
decoding with a decoding device a digital image from a bit stream comprising encoded data representative of said image, said image being divided into a plurality of blocks of pixels processed in a defined order, said decoding comprising the following steps, implemented for a block, called a transformed block:
decoding the coefficients of the transformed current block from data read in the bit stream;
dequantizing the decoded coefficients;
inverse transforming the current transformed block, said inverse transforming implementing two successive inverse transformation sub-steps, the first sub-step (D51) being applied to the current block, and the second sub-step to an intermediate block, resulting from the first sub-step;
wherein said at least one inverse transforming sub-step being applied to a block, called a block to be processed, from the current transformed block and the intermediate block, comprises applying a first inverse transform to at least one first vector of a length equal to that of one line or one column of the block to be processed and at least one second inverse transform distinct from the first, to at least one second vector of said block of length equal to that of one line or one column, respectively; and
a sub-step of forming the processed block, by positioning sequences of adjacent coefficients, respectively adjacent pixels of lengths equal to that of a column respectively a line, from the processed vectors.
